(19) United States
(12) Patent Application Publication
(10) Pub. No.: US 2012/0103031 A1
(43) Pub. Date: May 3, 2012

(54) SECURITY SYSTEM FOR MERCHANDISE SHELF

(75) Inventors: Jeffrey A. Grant, Charlotte, NC (US); David N. Berglund, Charlotte, NC (US)

(73) Assignee: INVUE SECURITY PRODUCTS, INC., Charlotte, NC (US)

(21) Appl. No.: 13/285,692

(22) Filed: Oct. 31, 2011

Related U.S. Application Data
(60) Provisional application No. 61/409,381, filed on Nov. 2, 2010.

(51) Int. Cl. E05B 73/00; B23P 11/00; E05B 47/02

(52) U.S. Cl. 70/14; 29/428

(57) ABSTRACT

A security system for a merchandise shelf includes an elongate rod having a free first end and a second end adapted to be secured on the shelf with at least one tether attached to an item of merchandise removably disposed on the rod. A locking nose includes a mounting plate adapted to be secured on the shelf and a housing configured for sliding movement relative to the mounting plate between an unlocked position and an unlocked position. A locking mechanism releasably locks the housing to the first end of the rod to retain the tether on the rod. A key is operable to transfer electrical power to unlock the locking mechanism and permit the housing to be moved to the unlocked position to remove the tether from the rod. The rod and mounting plate are secured on the shelf without accessing the underside.

### CROSS REFERENCE TO RELATED APPLICATION

This non-provisional application claims the benefit of U.S. Provisional Application No. 61/409,381 filed on Nov. 2, 2010, the entire disclosure of which is incorporated herein by reference.

### FIELD OF THE INVENTION

The present invention relates generally to security systems for deterring the theft of items of merchandise displayed on a merchandise shelf in a retail store. More particularly, the invention is a security system for a merchandise shelf that is configured to be installed from above the shelf. In an exemplary embodiment, the security system includes an anchor rod for receiving a tether attached to an item of merchandise and a locking nose that engages the anchor rod in a locked position to secure the tether onto the anchor rod.

### BACKGROUND AND RELATED ART

Retailers generally prefer to stock relatively high-value merchandise on a shelf in a retail store so that potential purchasers have an opportunity to view and examine the merchandise when making a decision whether to purchase the item. Unfortunately, providing potential purchasers with access to high-value merchandise necessarily increases losses due to theft, commonly referred to in the retail sales industry as “shrinkage.” In order to reduce shrinkage, some retailers have adopted a policy of displaying only one of the high-value items of merchandise on a shelf at a time, while storing the remaining items at a location that is inaccessible to the patrons, such as a back room or a locked cabinet behind a display counter, cash register or check-out stand. However, when the displayed item of merchandise is purchased there may be a significant period of time that another item of merchandise is not available on the shelf for a subsequent purchaser to view and examine. Furthermore, displaying only one item of merchandise on the shelf may discourage a potential purchaser from purchasing more than the one available item since they must wait for a store employee to retrieve another item or to stock the shelf with an additional item.

Other retailers place each item of merchandise inside a lockable transparent container (commonly referred to in the retail sales industry as a “keeper”) on the shelf. The keeper must be unlocked by an authorized store employee using a key device at a cash register or check-out stand to remove the merchandise. If the keeper is not unlocked and the item removed, an alarm will be activated when the keeper (and the merchandise) passes through a monitored exit of the store. In general, a keeper is a fairly effective deterrent to theft. However, a potential thief can obtain a stolen or duplicated key device to unlock the keeper and gain access to the merchandise. In certain instances, the relatively high value of the item of merchandise in the keeper justifies the consequences a potential thief may face in attempting to remove both the keeper and the merchandise from the store. Furthermore, resourceful thieves have developed means of disarming the keeper so that the keeper and the item of merchandise can be removed from the store without detection.

It is also known to lock an item of merchandise to the shelf itself or to a closed anchor bar secured to the shelf or to another fixed structure using a mechanical tether attached to the item of merchandise. However, installation of the anchor bar typically requires modification to the shelf, including forming holes through the shelf for receiving tamper-proof fasteners from above the shelf, or hidden fasteners from below the shelf. Thus, existing anchor bar and tether systems are typically time consuming and difficult to install, unattractive, and detract from the amount of display space available on the shelf for the items of merchandise. In addition, each tether must be provided with a separate lock mechanism for locking and unlocking the tether to and from the anchor bar.

Accordingly, there exists a need for a security system for deterring the theft of merchandise displayed on a shelf in a retail store that overcomes the aforementioned disadvantages. There exists a more particular need for a security system for a merchandise shelf that permits a retailer to securely display more than one item of merchandise on the shelf at the same time. There exists a further need for a security system for a merchandise shelf that can be used with or without a keeper. There exists a still further need for a security system for a merchandise shelf that does not require modification to the shelf or installation from below the shelf. There exists a still further need for a security system for a merchandise shelf that does not require a separate lock mechanism for each tether attached to an item of merchandise.

### BRIEF DESCRIPTION OF THE DRAWINGS

FIG. 1 is a perspective view of an exemplary embodiment of a security system for a merchandise shelf according to the present invention showing a plurality of items of merchandise displayed on the shelf with each item secured to the security system by a tether attached to at least one corresponding item of merchandise.

FIG. 2 is a perspective view of the security system of FIG. 1 showing a plurality of items of merchandise displayed on the shelf with each item contained within a keeper secured to the security system by a tether attached to the keeper.

FIG. 3A and FIG. 3B are top plan views of a merchandise security system according to the invention shown in the locked position and in the unlocked position, respectively.

FIG. 4 is a perspective view of the anchor rod of the merchandise security system shown in FIG. 3.

FIG. 5A and FIG. 5B are perspective views of the locking nose of the merchandise security system shown in the locked position and in the unlocked position, respectively.

FIGS. 6-8 are a series of perspective views illustrating a method according to the invention of installing the anchor rod onto a merchandise shelf from above the shelf without the use of tamper-proof or hidden fasteners.

FIGS. 9-12 are a series of perspective views illustrating a method according to the invention of installing the locking nose onto a merchandise shelf from above the shelf without the use of tamper-proof or hidden fasteners.

### DETAILED DESCRIPTION OF EXEMPLARY EMBODIMENTS OF THE INVENTION

The accompanying drawing figures illustrate one or more exemplary embodiments of a security system, indicated generally at 20, in accordance with the present invention for deterring the theft of items of merchandise displayed on a merchandise shelf, indicated generally at S, for example in a retail store. Broadly, the security system 20 comprises an anchor rod, indicated generally at 30, for receiving at least one tether 40 attached to an item of merchandise, and a locking nose, indicated generally at 50, for engaging the anchor rod in a locked position to secure the tether onto the anchor rod. The terms “anchor rod” and “locking nose” as used herein refer generically to any cooperating structures that are capable of receiving a tether on a first component and closing or locking the tether on the first component with a second component. Examples of a suitable “anchor rod” include a flexible wire and an arcuate bar, rod, elongate bracket, elongate clip or the like. Examples of a suitable “locking nose” include any housing containing a locking mechanism configured to engage the corresponding anchor rod. The anchor rod 30 and the locking nose 50 are each configured to be readily secured to the merchandise shelf S from above the shelf without the use of tamper-proof or hidden fasteners. The tether 40 may be coupled or attached to an item of merchandise, indicated generally at M, in any suitable manner. Alternatively, the item of merchandise M may be contained within a conventional keeper, indicated generally at K herein, and the tether 40 instead attached to the keeper in any suitable manner. In yet another embodiment, the item of merchandise M may be secured by an additional security device, for example a Spider Wrap™ available from Alpha High-Theft Solutions of Charlotte, N.C. and the tether 40 attached to the additional security device. Regardless, the tether 40 is further attached to the anchor rod 30 and the anchor rod is locked to the merchandise shelf M by the locking nose 50, as will be described.

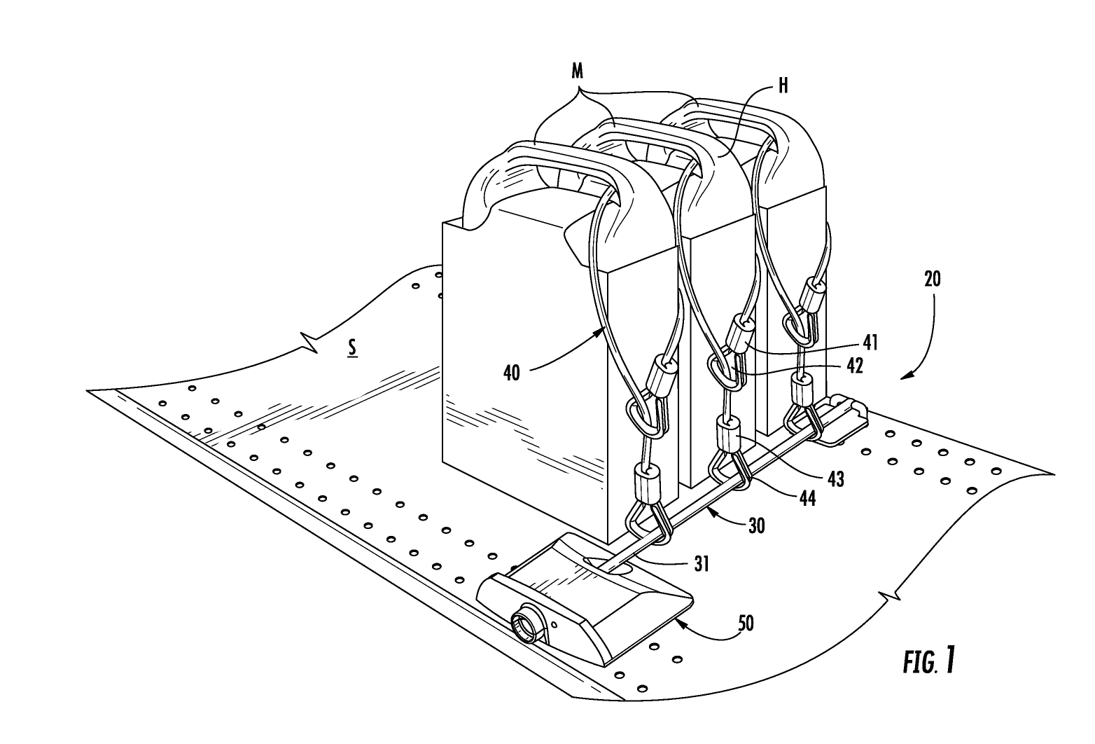

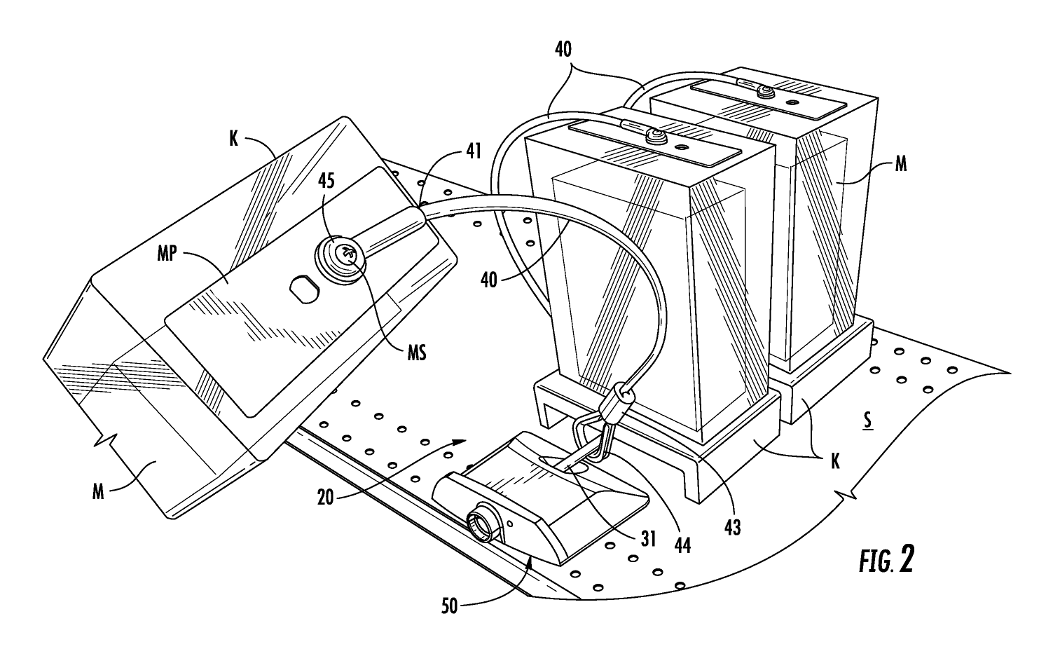

FIG. 1 illustrates a security system 20 for a merchandise shelf S with a plurality of items of merchandise M each secured on the anchor rod 30 of the security system by a tether 40 attached to the item of merchandise. As shown herein, a first end 41 of the tether 40 is formed with a loop 42 sized sufficiently to permit an opposite second end 43 of the tether to be passed through the loop. The second end 43 of the tether 40 has a cable eye 44 fixed thereto that is provided with an opening sized sufficiently to be received on the anchor rod 30. For example, the loop 42 on the first end 41 of the tether 40 may be passed through or wrapped around a handle H, or other structure of the item of merchandise M forming an opening of sufficient size, and the second end 43 of the tether passed through the loop 42 so that the tether is secured to the handle of the item. The cable eye 44 at the second end 43 of the tether 40 is then passed over a first end 31 of the anchor rod 30 and the anchor rod is locked to the merchandise shelf S, as will be described, to secure the tether and the item of merchandise M on the shelf. In an alternative arrangement, FIG. 2 illustrates the security system 20 with a plurality of items of merchandise M each contained within a keeper K that is secured to the anchor rod 30 of the security system by a tether 40 attached to the keeper. As shown herein, the keeper K is provided with a tether mounting plate MP and the first end 41 of the tether 40 is provided with a cable eye 45 sized to receive a mounting stud MS of the mounting plate so that the tether is securely attached to the keeper. If desired, the mounting stud MS of the mounting plate MP and the cable eye 45 may be rotatably coupled so that the tether 40 is free to swivel relative to the keeper K. Regardless, the cable eye 44 at the second end 43 of the tether 40 is then passed over the first end 31 of the anchor rod 30 and the anchor rod secured to the merchandise shelf S by the locking nose 50 as previously described to secure the tether and the keeper K containing the item of merchandise M to the anchor rod on the merchandise shelf.

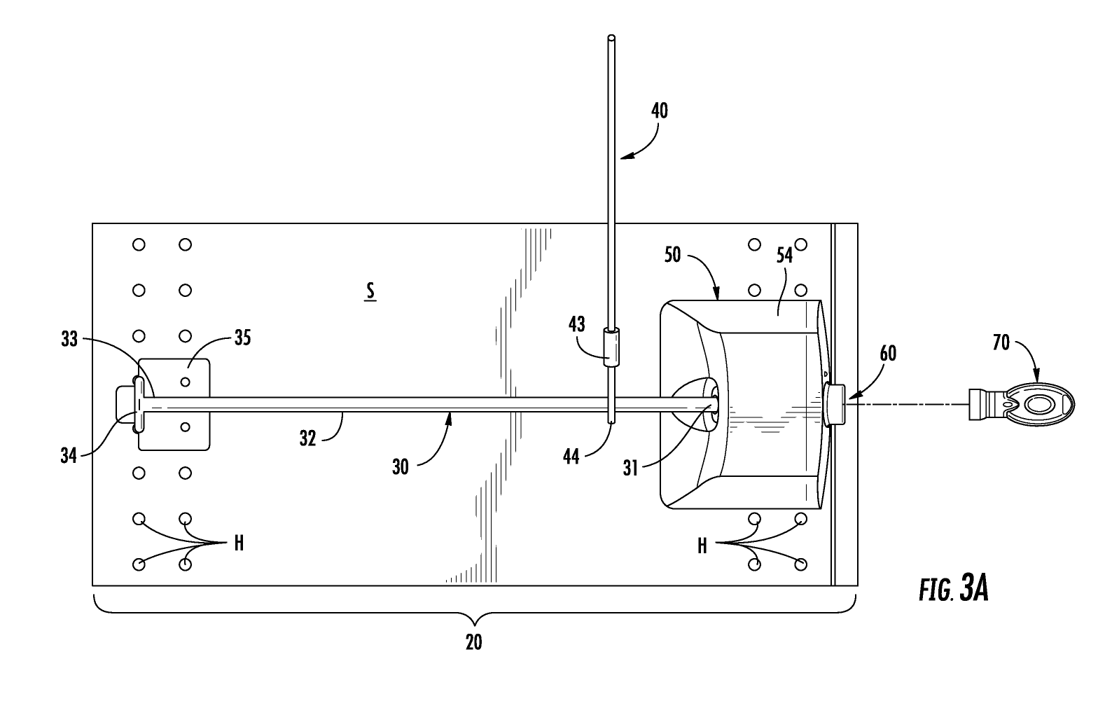

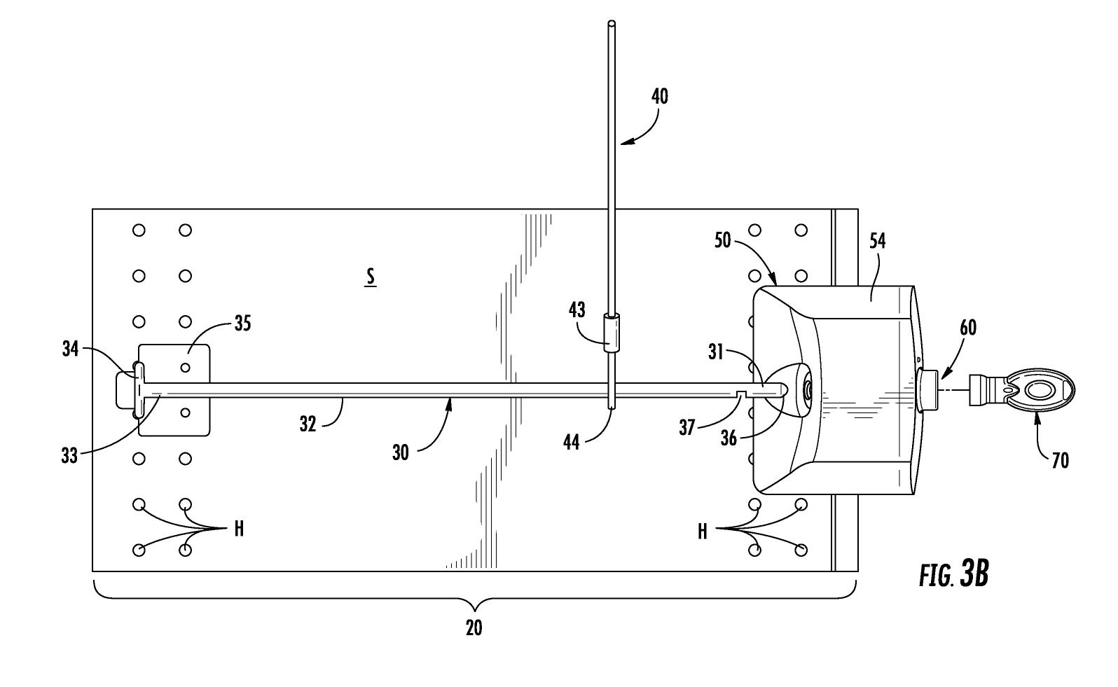

An exemplary preferred embodiment of a security system 20 according to the present invention is shown in FIG. 3. As previously mentioned, the security system 20 comprises an anchor rod 30 for receiving thereon at least one tether 40 attached to an item of merchandise (not shown). The security system 20 further comprises a locking nose 50 comprising a locking mechanism for releasably locking the locking nose to the anchor rod in a locked position (shown in FIG. 3) and thereby secure the anchor rod to a merchandise shelf S so that the item of merchandise is in turn locked to the shelf. As shown herein, the anchor rod 30 resembles a conventional merchandise display hook for a pegboard, slatwall, wire grid or horizontal bar support structure. The anchor rod 30 comprises an elongate wire or rod 32 that has a free first end 31 for receiving one or more tethers 40 each attached to an item of merchandise (or alternatively, to a keeper containing an item of merchandise) to be displayed on the merchandise shelf S. The opposite second end 33 of the elongate rod 32 is provided with one or more prongs (commonly referred to as “antlers”) 34 that are configured to be received within one or more corresponding holes H formed through the merchandise shelf S. The holes H are arranged in a predetermined pattern of sized, shaped and spaced apart openings through the merchandise shelf S. For purposes of explanation of the present invention, the holes H are provided only adjacent the rear (inner) and front (outer) edges of the merchandise shelf S. However, the predetermined patterns of holes H may be provided in any desired locations on the merchandise shelf S as long as the anchor rod 30 and the locking nose 40 are configured to cooperate with the locations of the holes H.

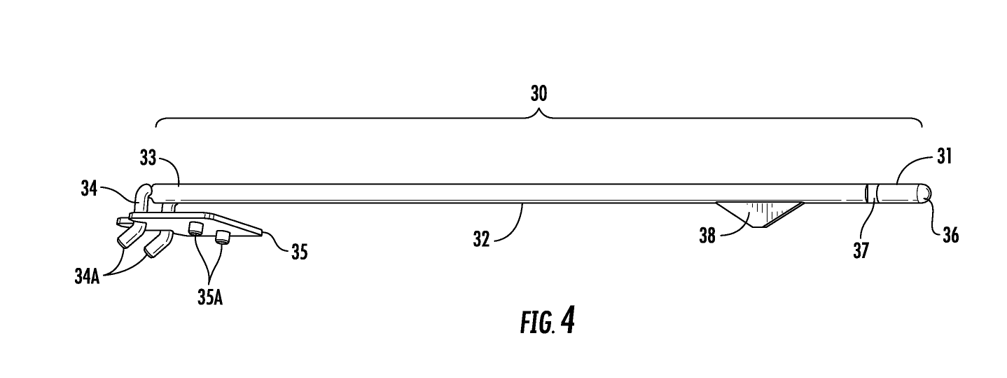

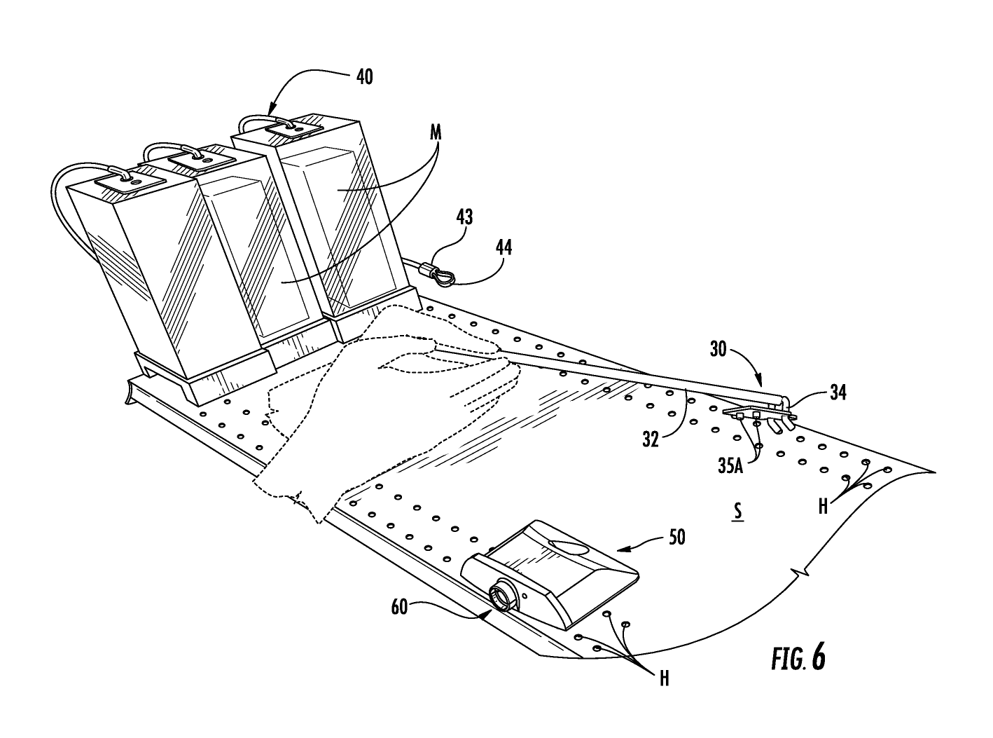

As best shown in FIG. 4, the antlers 34 extend through corresponding ones of the predetermined pattern of holes H formed in the merchandise shelf S. Preferably, the free end of each antler 34 is angled or bent to form a hook-like portion 34A so that rod 32 must be first tilted upwardly and the antlers 34 inserted through the holes H at an acute angle relative to the merchandise shelf S. In this manner, the second end 33 of the rod 32 cannot be simply raised vertically off the merchandise shelf S when the rod is substantially parallel to the upper surface of the shelf. If desired, the second end 33 of the rod 32 may be provided with a substantially flat plate portion 35 to be positioned between the upper surface of the merchandise shelf S and the rod 32. Plate portion 35 provides additional bending stiffness and ensures that the antlers 34 remain properly located within the holes H of the shelf. The plate portion 35 may comprise one or more downwardly depending pegs 35A (FIG. 6) sized and shaped to engage other ones of the holes H on the merchandise shelf S to thereby help locate and align the anchor rod 30 relative to the shelf, as well as to more evenly distribute forces transferred from the anchor rod 30 to the shelf during an attempted theft. As will be readily apparent to those skilled in the art, alternative configurations of antlers 34 are possible as long as the antlers are sized, shaped and spaced apart in a manner that corresponds to the predetermined pattern of holes H provided on the merchandise shelf S. Regardless, the first end 31 of the rod 32 has a taper 36 and the rod has a notch 37 formed therein adjacent the first end. As will be described, the taper 36 and the notch 37 are configured to engage a lock mechanism of the locking nose 50 as the locking nose is moved from the unlocked position to the locked position.

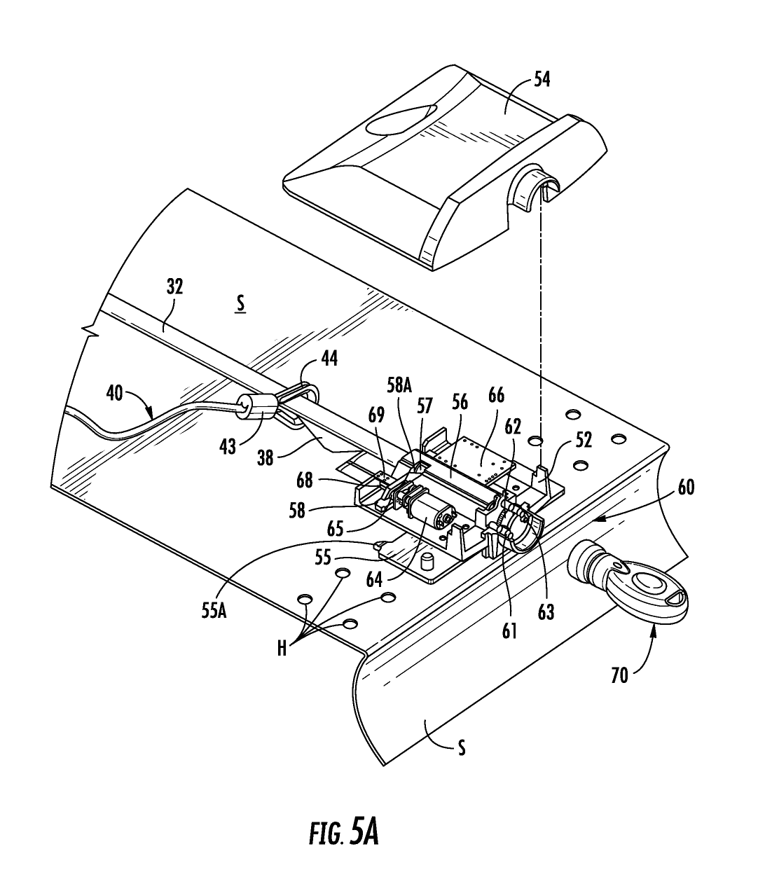

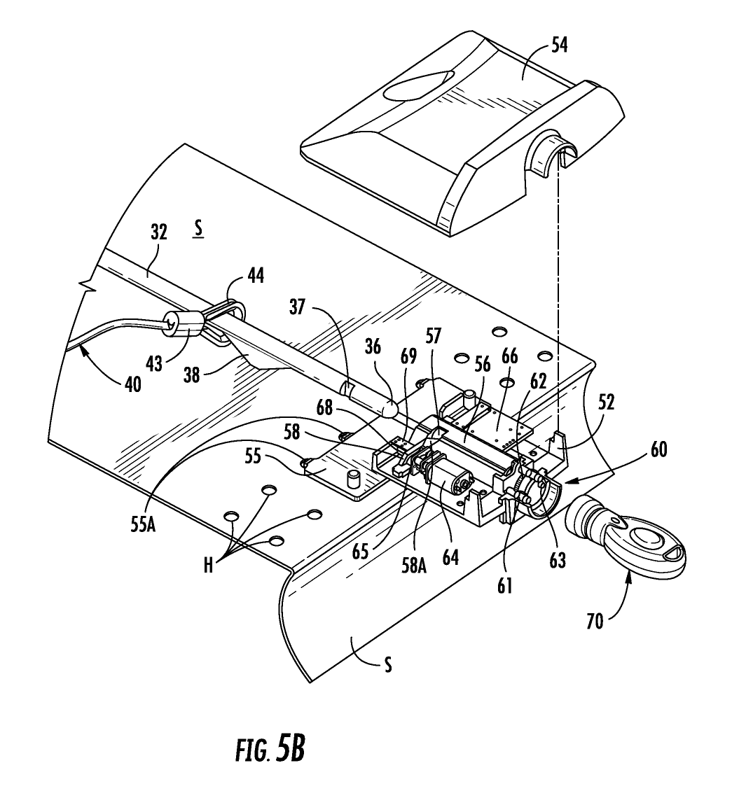

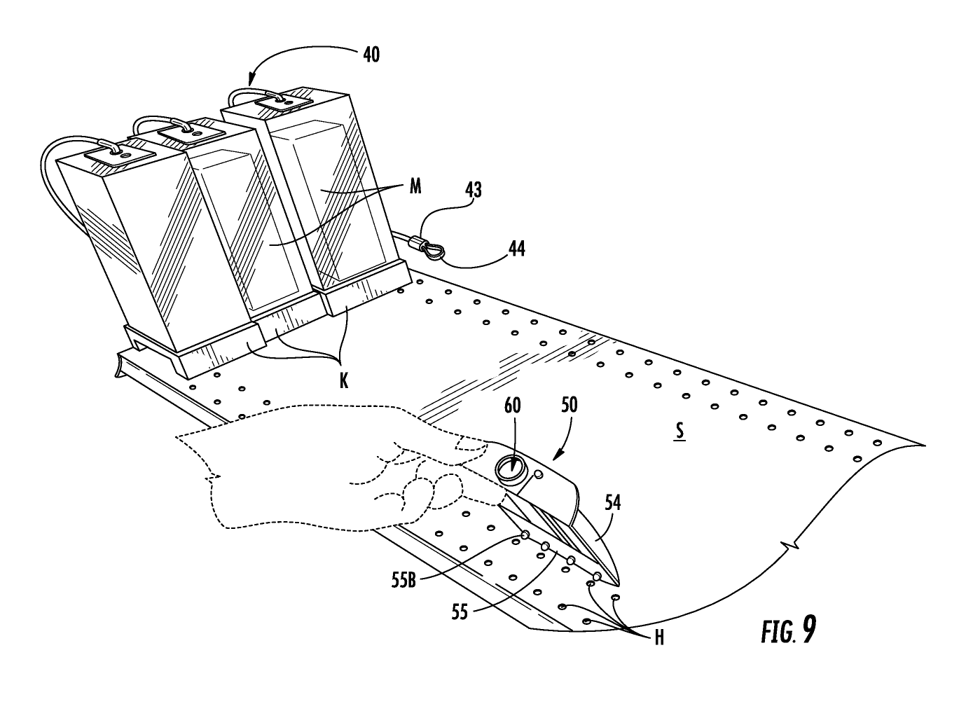

As best shown in FIGS. 5A and 5B, locking nose 50 of the security system 20 comprises a housing bottom 52 and a removable housing top 54. The housing top 54 may be attached to the housing bottom 52 in any manner, for example by tamper-proof fasteners or flexible snap fittings, suitable to prevent easy access to the components disposed on the housing bottom within the locking nose 50. Furthermore, the housing bottom 52 and the housing top 54 are slidably mounted on a mounting plate 55 that is positioned between the housing bottom and the upper surface of the merchandise shelf S. The mounting plate 55 is configured to engage the predetermined pattern of holes H on the merchandise shelf S in much the same manner as the antlers 34 of the anchor rod 30 engage the holes H on the opposite (i.e. rear) edge of the shelf. Accordingly, the mounting plate 55 is provided with at least one, and preferably a plurality, of hook-like portions 55A that extend outwardly and downwardly from the mounting plate to engage corresponding holes H on the merchandise shelf S. The mounting plate 55 may further comprise one or more downwardly depending pegs 55B (FIG. 9) sized and shaped to engage other ones of the holes H on the merchandise shelf S to thereby help locate and align the locking nose 50 relative to the shelf, as well as to more evenly distribute forces transferred from the locking nose 50 to the shelf during an attempted theft.

In the exemplary embodiment shown herein, the housing bottom 52 of the locking nose 50 defines an elongate, generally hollow, tunnel-like rail 56 that is sized and shaped to receive the free end 31 of the rod 32 therein when the locking nose is in the locked position. Rail 56 has a notch 57 formed therein at a medial location of the rail that corresponds to the location of the notch 37 formed in rod 32 when the locking nose 50 is in the locked position. Notch 57 of rail 56 is sized and shaped to receive a lock bolt 58 therein that engages the notch 37 of rod 32 in the locked position. Preferably, but not essentially, the bolt 58 defines an angled leading edge 58A and is biased by a biasing member, for example by a linear coil spring (not shown), in the direction of notch 57. In this manner, bolt 58 will move away from notch 57 in rail 56 against the biasing force of the spring as leading edge 58A engages the taper 36 on the free end 31 of rod 32 when locking nose 50 is moved parallel to the merchandise shelf S relative to mounting plate 55 from the unlocked position to the locked position. Furthermore, the biasing force of the spring will cause bolt 58 to be disposed within notch 57 of rail 56 and within notch 37 of rod 32 in the locked position. As such, the locking nose 50 will remain in the locked position until the bolt 58 is withdrawn from notch 37 and notch 57 against the biasing force of the spring. Those of ordinary skill in the art will ready appreciate that the biasing force may be provided by any suitable biasing member that biases bolt 58 into notch 57 of rail 56, yet permits bolt 58 to move out of notch 57 as leading edge 58A engages taper 36 on rod 32 sufficiently for rod 32 to be received within rail 56. Furthermore, rod 32, taper 36, notch 37, rail 56, notch 57 and leading edge 58A of bolt 58 may be configured in any desirable manner that allows locking nose 50 to engage and retain anchor rod 30 in a locked position.

Together, housing bottom 52 and housing top 54 of locking nose 50 define a recessed keyway 60 sized and shaped to receive a key 70 that operates to unlock the locking mechanism of the locking nose, and thereby permit the locking nose to be moved from the locked position to the unlocked position. Key 70 may be any mechanical, electrical, electromechanical, magnetic or optical key suitable for unlocking the locking mechanism of the locking nose 50. Those skilled in the art will readily appreciate that numerous such keys exist, and more particularly, many existing keys are capable with minimal modification to withdraw lock bolt 58 from notch 37 of rod 32 sufficiently to permit rail 56 to move clear of the free end 31 of rod 32. In the exemplary embodiment shown herein, keyway 60 is configured to receive a combination magnetic and electronic key 70 that is proprietary to the assignee of the present invention, and therefore, cannot be replicated easily by a potential thief. Keyway 60 comprises at least one, and preferably a plurality, of key magnets 61 and a key printed circuit board (PCB) 62. Key magnets 61 are made of an electrically conductive and magnetic material. Conversely, key 70 comprises an annular first electrical contact made of an electrically conducting and magnetically attractable material. The key magnets 61 function to attract, align and retain the first electrical contact of the key 70 in an electrically conductive engagement position with the key magnets. An electrically conductive post, or pin, 63 is provided on the key PCB 62 that cooperates with an annular second electrical contact of the key 70 in an electrically conductive engagement position. If desired, the pin 63 may be biased outwardly from the keyway 60 away from mounting plate 55 to ensure electrical contact with the annular second contact despite variations in the depth of the recessed keyway and the axial length of the key. As a result, the key magnets 61 and the first electrical contact of the key 70 define a ground, or negative, portion of an electrical circuit, while the pin 63 of the key PCB 62 and the second electrical contact of the key 70 define a positive portion of the electrical circuit. If desired, key PCB 62 and key 70 may each be provided with a transceiver for exchanging data, and in particular, a security code or “handshake” for authenticating the key 70. The exchange of data between the key PCB 62 and the key 70 may be accomplished in any known manner, for example electrically, optically or by inductance, including magnetic inductance. As such, the key 70 may provide electrical power, data, or both electrical power and data to the PCB 62 of the locking nose 50.

As previously mentioned, locking nose 50 further comprises a locking mechanism for releasably locking the locking nose to the anchor rod 30. In the embodiment shown herein, locking nose 50 includes a lock motor 64 and a lock motor printed circuit board (PCB) 66 disposed within housing bottom 52. Lock motor 64 is electrically connected to and controlled by lock motor PCB 66 in a conventional manner to move leading edge 58A of lock bolt 58 out of engagement with notch 37 of rod 32, and thereby permit locking nose 50 to move from the locked position to the unlocked position. In the embodiment shown herein, lock motor 64 comprises a cam 65 that engages a corresponding cam surface on the lock bolt 58 to drive the lock bolt in the direction away from notch 57 of rail 56 against the biasing force exerted on the lock bolt by the biasing member. Once the locking nose 50 moves away from the locked position towards the unlocked position, the cam 65 releases the lock bolt 58 such that the lock bolt is once again biased in the direction of the notch 57 of rail 56. In this manner, the lock bolt 58 will automatically engage the notch 37 of rod 32 when the locking nose 50 is moved back from the unlocked position to the locked position. Lock motor 64 and lock motor PCB 66 may be powered by an internal battery (not shown) disposed within housing bottom 52. In a preferred embodiment, however, power for the lock motor 64 and the lock motor PCB 66 is provided by the key 70. For example, the key 70 may contain an internal power source, such as a conventional battery or rechargeable battery, or alternatively, may be electrically connected to an external power source. Regardless, the key 70 is configured to transfer electrical power from the power source to the lock motor 64 and the lock motor PCB 66 through the electrical circuit defined by key magnets 61, pin 63 and the first and second electrical contacts of the key 70. In this manner, the incremental cost of the source of power and the necessity to replace a battery source of power are limited to the key 70 and not included in the locking nose 50. It will be readily apparent that a single key 70 can be configured for use with the locking nose 50 of multiple security systems 20. Furthermore, the key 70 can be used with other similar security systems and devices at the same retail store location.

If desired, the housing bottom 52 (together with the housing top 54 in the assembled configuration) may be configured to move automatically from the locked position to the unlocked position. In particular, the housing bottom 52 may be biased in the direction away from the free end 31 of rod 32 of anchor rod 30 by a biasing member. In a preferred embodiment, at least one elastic biasing spring (not shown) is disposed between the mounting plate 55 and the housing bottom 52 such that the biasing spring is compressed when the locking nose 50 is moved from the unlocked position to the locked position. Consequently, the biasing force of the biasing spring will automatically move the locking nose 50 from the locked position towards the unlocked position when lock bolt 58 is moved out of engagement with notch 37 of rod 32 by lock motor 64. As previously mentioned, lock bolt 58 is similarly biased towards notch 57 of rail 56 so that the lock bolt will automatically engage notch 37 of rod 32 when locking nose 50 is moved from the unlocked position to the locked position. Preferably, the surface friction resistance between mounting plate 55 and the lower surface of housing bottom 52 is selected so that locking nose 50 is easily moved from unlocked position to the locked position and moves easily from the locked position to the unlocked position under the influence of the biasing force of the biasing spring. Also if desired, housing bottom 52 may be provided with an optional limit switch 68 and associated limit switch PCB 69 for activating an audible or visible alarm in the event that the housing bottom is separated from the merchandise shelf S. As will be readily apparent to those skilled in the art, limit switch PCB 69 could comprise a power source and an audible alarm or visible indicator (e.g. LED) in a known manner.

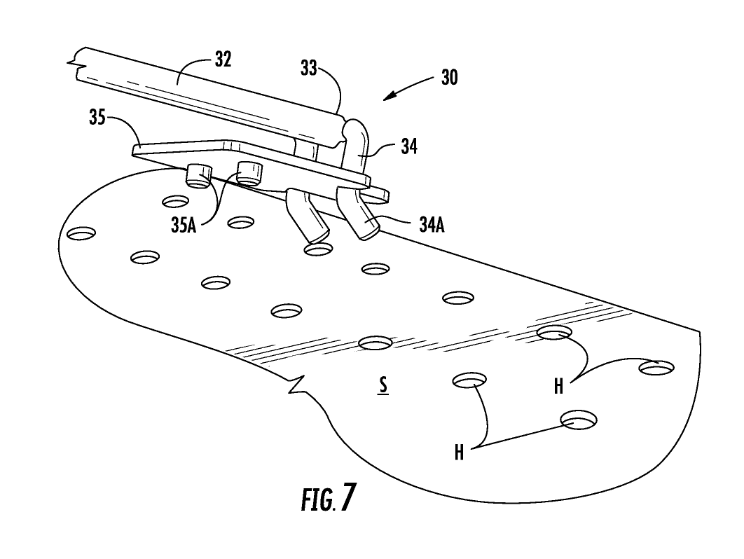

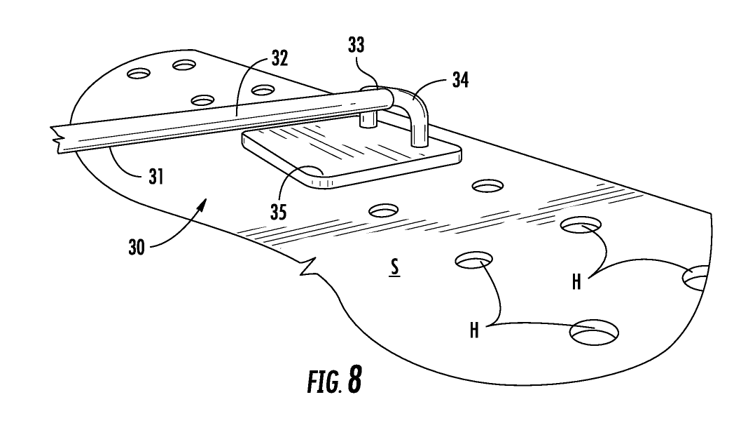

FIGS. 6-8 illustrate an exemplary embodiment of a method of installing anchor rod 30 onto a merchandise shelf S having a predetermined pattern of holes H. As shown in FIG. 6, anchor rod 30 is first tilted at an upward angle between about thirty (30) and about sixty (60) degrees relative to the upper surface of the merchandise shelf S. In this position, antlers 34 of anchor rod 30 are next inserted into and then guided through corresponding holes H on the merchandise shelf S, as shown in FIG. 7. As shown in FIG. 8, the free end 31 of anchor rod 30 is then rotated downwardly about antlers 34 until rod 32 is substantially parallel to the upper surface of the merchandise shelf S. If provided, the downwardly depending pegs of the plate portion 35 of the anchor rod 30 are then positioned within the corresponding other holes H on the merchandise shelf S to thereby help locate and align the anchor rod 30 relative to the shelf, as well as to more evenly distribute forces transferred from the anchor rod 30 to the shelf during an attempted theft. If desired, rod 32 of anchor rod 30 may be provided with a downwardly depending rib 38 for contacting the upper surface of the merchandise shelf S such that the free end 31 of the rod will be aligned with the elongate opening defined by rail 56 of locking nose 50. It should also be noted that one or more tethers 40 may be placed on the rod 32 of anchor rod 30 before or after the anchor rod is positioned in the configuration shown in FIG. 8.

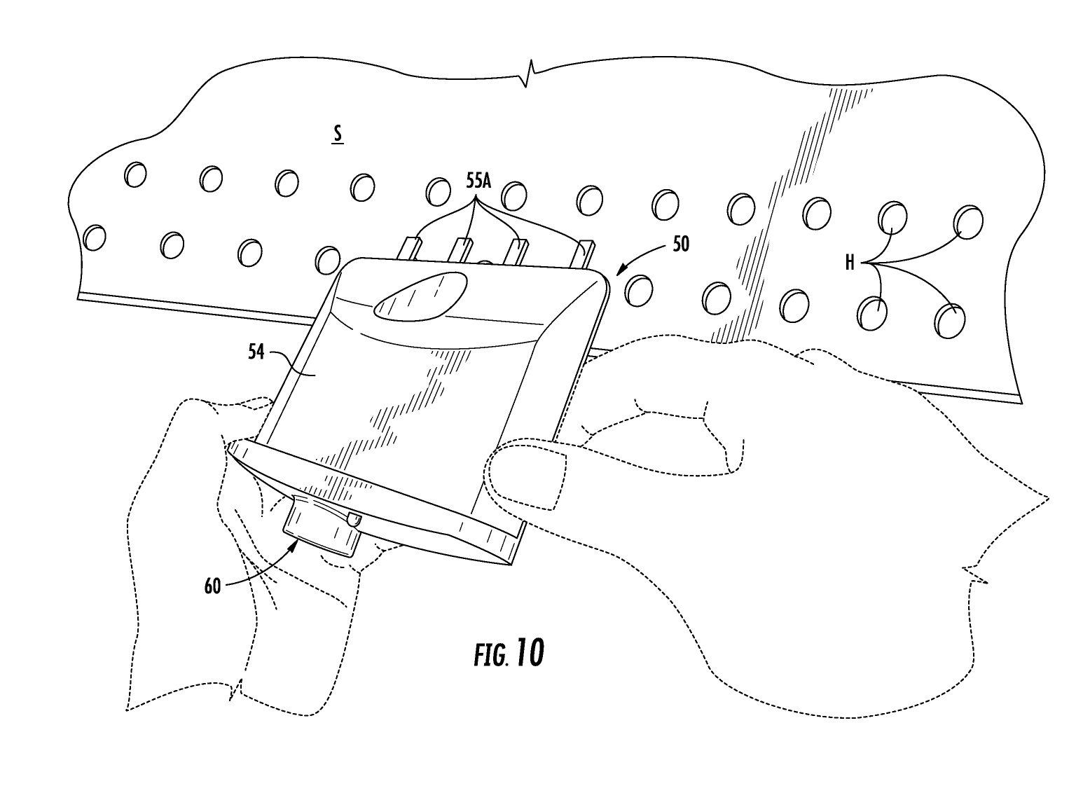

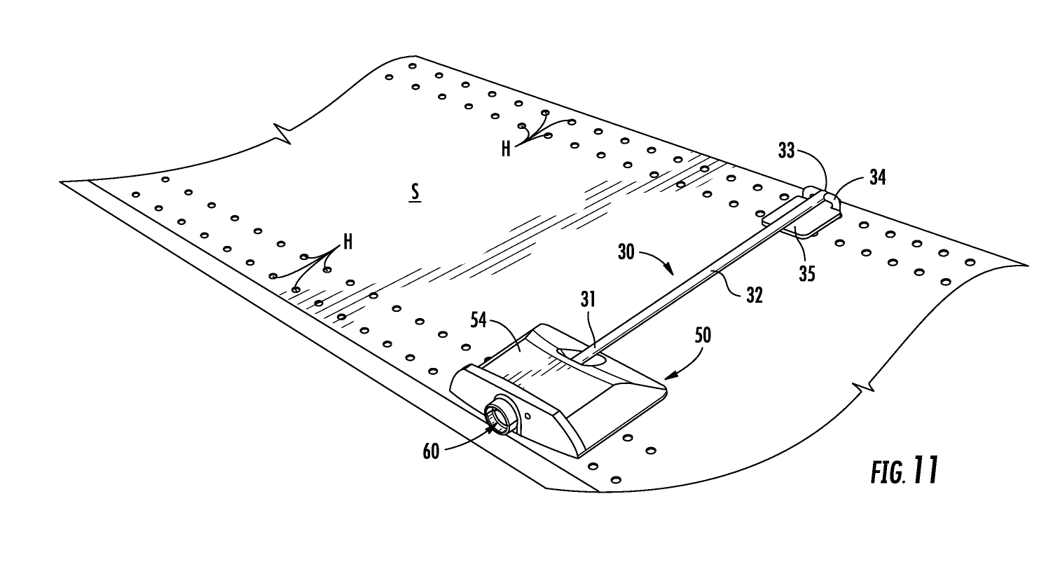

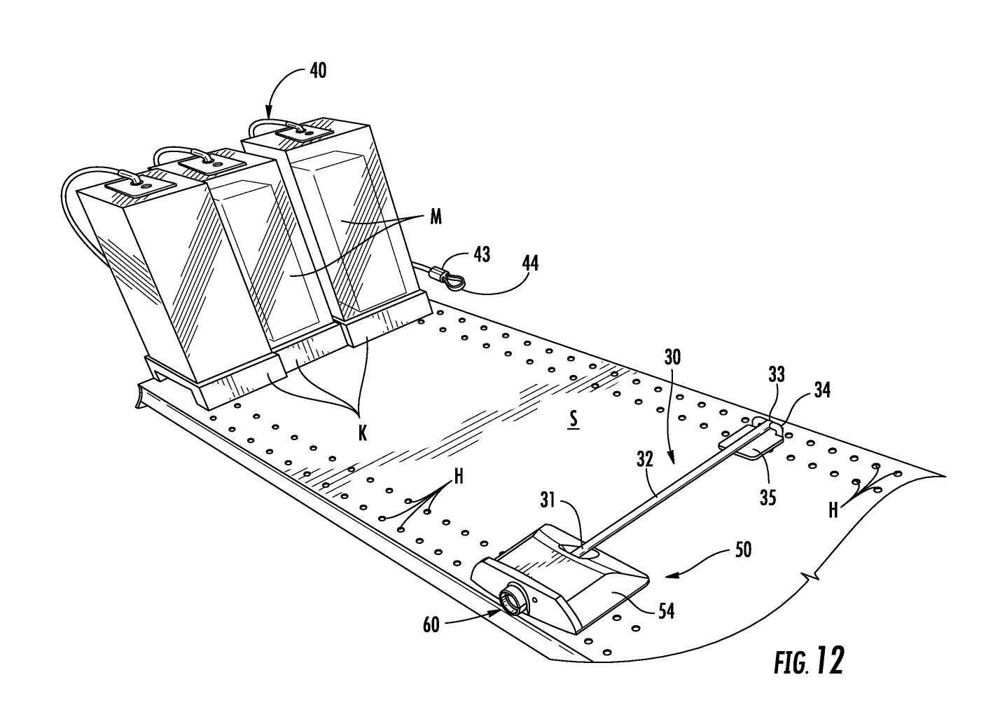

FIGS. 9-12 illustrate an exemplary embodiment of a method of installing the locking nose 50 onto the merchandise shelf S, and subsequently, locking the locking nose on the anchor rod 30. As shown in FIG. 9, locking nose 50, including mounting plate 55, housing bottom 52 and housing top 54, is first tilted at an upward angle between about thirty (30) and about sixty (60) degrees relative to the upper surface of the merchandise shelf S. In this position, hook-like portions 55A of mounting plate 55 are inserted into and then guided through corresponding holes H on the merchandise shelf S, as shown in FIG. 10. As shown in FIG. 11, the locking nose 50 is then rotated downwardly about hook-like portions 55A until mounting plate 55 is substantially parallel to the upper surface of the merchandise shelf S. As previously mentioned, mounting plate 55 of locking nose 50 may be provided with downwardly depending pegs 55B for engaging the corresponding other holes H on merchandise shelf S to thereby help locate and align the locking nose relative to the shelf, as well as to more evenly distribute forces transferred from the locking nose 50 to the shelf during an attempted theft. The locking nose 50 is next moved from the unlocked position (FIG. 11) to the locked position shown in FIG. 12 by sliding housing bottom 52 together with housing top 54 relative to mounting plate 55 in the direction of anchor rod 30 until the free end 31 of rod 32 is received within the elongate opening defined by rail 56 of the locking nose with the lock bolt 58 disposed within the notch 37 of the rod. It should be noted that in this position the at least one tether 40 is locked onto the anchor rod 30 and cannot be removed until the locking nose is moved from the locked position (FIG. 12) to the unlocked position (FIG. 11) in the manner previously described. It should also be noted that lock bolt 58 automatically moves against its biasing force sufficiently out of rail 56 to permit the free end 31 of the rod 32 to pass into the elongate opening of the rail, and then automatically moves under the influence of its biasing force into engagement with the notch 37 of the rod.

The foregoing has described one or more exemplary embodiments of a security system for a merchandise shelf including an anchor rod for receiving at least one tether thereon with the tether being attached to an item of merchandise, or alternatively, to a keeper containing an item of merchandise. The security system further includes a locking nose for locking the anchor rod to the merchandise shelf in a locked position with the at least one tether disposed on the anchor rod. In the exemplary embodiments shown and described herein, the security system engages a predetermined pattern of holes on the merchandise shelf and is configured to be installed without the use of tamper-proof fasteners or the need to access standard fasteners from below the shelf. Accordingly, the security system can be installed entirely from above the merchandise shelf. Furthermore, the anchor rod and the locking nose of the security system permit a retailer to display and protect more than one tethered item of merchandise on the shelf at the same time, with or without a keeper. Still further, the anchor rod and the locking nose of the security system do not require a separate lock mechanism for each tether attached to an item of merchandise. Exemplary and preferred embodiments of a security system for a merchandise shelf have been shown and described herein for purposes of illustrating and enabling the best mode of the invention. Those of ordinary skill in the art, however, will readily understand and appreciate that numerous variations and modifications may be made to the exemplary and preferred embodiments without departing from the spirit and scope of the invention. Accordingly, all such variations and modifications are intended to be encompassed by the appended claims, which particularly point out and distinctly claim the subject matter regarded as the invention.

That which is claimed is:

1. A security system for a merchandise shelf comprising:
an anchor rod comprising an elongate rod having a first end and a second end opposite the first end that is adapted to be secured on the merchandise shelf
at least one tether configured to be attached to at least one item of merchandise with the tether removably disposed on the rod; and
a locking nose comprising a mounting plate adapted to be secured on the merchandise shelf adjacent the first end of the rod and a housing configured for sliding movement relative to the mounting plate, the locking nose further comprising a locking mechanism for releasably locking the locking nose to the first end of the rod and to thereby retain the tether attached to the item of merchandise on the rod.

2. A security system according to claim 1, wherein the merchandise shelf has one or more holes formed therethrough and wherein the second end of the rod comprises at least one prong configured to engage a corresponding one of the one or more holes formed in the merchandise shelf to secure the second end of the rod on the merchandise shelf.

3. A security system according to claim 1, wherein the merchandise shelf has one or more holes formed therethrough and wherein the mounting plate of the locking nose comprises at least one hook-like portion configured to engage a corresponding one of the one or more holes formed in the merchandise shelf to secure the mounting plate of the locking nose on the merchandise shelf.

4. A security system according to claim 1, wherein the merchandise shelf has a plurality of holes formed therethrough and wherein the second end of the rod comprises at least one prong for engaging one or more holes of the merchandise shelf and the mounting plate of the locking nose comprises at least one hook-like portion for engaging one or more other holes of the merchandise shelf to secure the rod and the locking nose to the merchandise shelf when the locking nose is locked to the first end of the rod.

5. A security system according to claim 4, wherein the plurality of holes formed through the merchandise shelf is arranged in a predetermined pattern.

6. A security system according to claim 1, wherein the locking nose further comprises a housing slidably mounted on the mounting plate and movable relative to the mounting plate between an unlocked position and a locked position to lock the locking nose to the first end of the rod.

7. A security system according to claim 6, wherein the first end of the rod has a notch formed therein and wherein the housing comprises a rail having a notch formed therein that corresponds to the location of the notch formed in the first end of the rod in the locked position.

8. A security system according to claim 7, wherein the notch formed in the rail is sized and shaped to receive a lock bolt therein that engages the notch formed in the first end of the rod in the locked position.

9. A security system according to claim 8, wherein the lock bolt is biased in the direction of the notch formed in the rail so that the lock bolt moves away from the notch formed in the rail as the housing of the locking nose moves from the unlocked position towards the locked position and is biased into engagement with the notch formed in the first end of the rod when the locking nose is in the locked position.

10. A security system according to claim 9, wherein the lock bolt defines an angled leading edge and wherein the first end of the rod comprises a taper that is engaged by the leading edge of the lock bolt as the housing of the locking nose moves from the unlocked position towards the locked position.

11. A security system according to claim 6, wherein the housing comprises a locking mechanism for locking the locking nose to the first end of the rod in the locked position and defines a keyway configured to receive a key that is operable to unlock the locking mechanism and thereby permit the housing of the locking nose to be moved from the locked position to the unlocked position.

12. A security system according to claim 11, wherein the key is operable to transfer electrical power to the locking mechanism to permit the housing of the locking nose to be moved from the locked position to the unlocked position.

13. A security system according to claim 11, wherein at least one key magnet made of an electrically conducting and magnetically attractable material is disposed within the keyway for attracting, aligning and retaining a first electrical contact of the key in an electrically conductive engagement position with the key magnet.

14. A security system according to claim 13, wherein at least one electrically conductive pin disposed within the keyway is electrically connected to a printed circuit board (PCB) located within the housing and cooperates with a second electrical contact of the key in an electrically conductive engagement position.

15. A security system according to claim 14, wherein the at least one key magnet disposed within the keyway and the first electrical contact of the key define a negative ground portion of an electrical circuit between the key and the printed circuit board (PCB) located within the housing and wherein the at least one pin disposed within the keyway and the second electrical contact of the key define a positive portion of the electrical circuit.

16. A security system according to claim 11, wherein the key exchanges a security code with a printed circuit board (PCB) located within the housing to authenticate the key for use with the locking nose to unlock the locking mechanism.

17. A method of installing a security system onto a merchandise shelf to protect an item of merchandise from theft, comprising:
providing an anchor rod comprising an elongate rod having a first end and a second end opposite the first end that is adapted to be secured on the merchandise shelf;
securing the second end of the rod on the merchandise shelf from above the merchandise shelf without a need to access the underside of the merchandise shelf;
providing at least one tether attached to an item of merchandise;
disposing the tether on the first end of the rod;
providing a locking nose comprising a mounting plate adapted to be secured on the merchandise shelf adjacent the first end of the rod and a housing configured for sliding movement relative to the mounting plate, the locking nose further comprising a locking mechanism for releasably locking the locking nose to the first end of the rod;
securing the mounting plate of the locking nose on the merchandise shelf from above the merchandise shelf without a need to access the underside of the merchandise shelf;
moving the housing of the locking nose from an unlocked position to a locked position such that the locking mechanism locks the locking nose to the first end of the rod to thereby retain the tether attached to the item of merchandise on the rod.

18. A method according to claim 17,
wherein the merchandise shelf has a plurality of holes formed therethrough and arranged in a predetermined pattern;
wherein the second end of the rod comprises at least one prong;
wherein the mounting plate of the locking nose comprises at least one hook-like portion;
wherein securing the second end of the rod to the merchandise shelf comprises engaging the at least one prong of the rod with a corresponding one of the plurality of holes formed through the merchandise shelf; and
wherein securing the mounting plate of the locking nose to the merchandise shelf comprises engaging the at least one hook-like portion of the mounting plate with a corresponding other one of the plurality of holes formed through the merchandise shelf.

19. A method according to claim 17, wherein the housing of the locking nose defines a keyway for receiving a key and further comprising disposing the key within the keyway and transferring electrical power from the key to operate the locking mechanism and thereby permit the housing of the locking nose to be moved from the locked position to the unlocked position.

20. A method according to claim 19, further comprising removing the tether from the first end of the rod to permit a customer to purchase the item of merchandise.
